(19) United States
(12) Patent Application Publication
(10) Pub. No.: US 2026/0314836 A1
(43) Pub. Date: Oct. 15, 2026

(54) COMPACT FOLDABLE AND ADJUSTABLE BED

(71) Applicant: Nisco Co., Ltd, Rugao (CN)

(72) Inventors: Wei Wang, Rugao (CN); Jian Xie, Rugao (CN); Fahuan Zhang, Rugao (CN)

(21) Appl. No.: 19/697,751

(22) Filed: Jun. 4, 2026

Related U.S. Application Data
(63) Continuation-in-part of application No. 19/640,515, filed on Apr. 7, 2026.
(60) Provisional application No. 63/820,757, filed on Jun. 10, 2025.
(60) Provisional application No. 63/791,859, filed on Apr. 21, 2025.

(30) Foreign Application Priority Data
Apr. 9, 2025 (CN) 202520663284.6
Jun. 6, 2025 (CN) 202521158038.1

(51) Int. Cl. A47C 20/04; A47C 19/12

(52) U.S. Cl. CPC A47C 20/041; A47C 19/122

(57) ABSTRACT

A compact foldable and adjustable bed includes a base frame having front and rear support frames hinged to each other. The front support frame comprises a front support beam, a front connection beam, and two front crank-type side rails, each having horizontal and inclined portions. Front and rear drive assemblies are placed at the front and rear support frames and are operatively connected to an upper limb board and a lower limb board, respectively. The front and rear support frames fold about the hinge to transition between an expanded state and a storage state. The drive assemblies interleave in the storage state. The front support beam provides structural rigidity, the front connection beam provides folding clearance, and the front crank-type side rails increase overall frame thickness to internally accommodate pivotal travel of the flipping assemblies, enabling the bed to rest flat on a supporting surface without external support legs.

### CROSS-REFERENCE TO RELATED PATENT APPLICATIONS

This application claims priority to and the benefit of U.S. Provisional Patent Application No. 63/820,757 filed June 10, 2025, and China Patent Application No. 202521158038.1 filed June 6, 2025, which are incorporated herein in their entireties by reference.

This application is also a continuation-in-part application of U.S. Patent Application No. 19/640,515 filed April 7, 2026, which claims priority to and the benefit of U.S. Provisional Patent Application No. 63/791,859 filed April 21, 2025 and China Patent Application No. 202520663284.6 filed April 9, 2025, which are incorporated herein in their entireties by reference.

### FIELD OF THE INVENTION

The invention relates generally to a bed, and more particularly to a compact, foldable, and adjustable bed with an optimized structural layout that enables space-efficient storage, flat-surface compatibility, and multi-angle adjustability.

### BACKGROUND OF THE INVENTION

Foldable and adjustable beds have gained popularity due to their adjustable positioning capabilities and transportable form factors. However, conventional designs suffer from several structural and functional limitations. First, traditional folding beds typically rely on external support legs to provide clearance for internal driving mechanisms. This reliance increases overall height, prevents the bed from being placed directly on flat surfaces or atop existing bed frames, and hinders compact storage and logistics. Second, the spatial arrangement of flipping mechanisms in prior art designs often results in bulky dimensions when folded, making them unsuitable for space-constrained environments such as urban apartments, recreational vehicles, or temporary housing. Third, conventional linkage systems frequently employ rigid contact points between driving links and bed boards, leading to increased friction, mechanical wear, operational noise, and reduced service life. Finally, existing leg support sections often lack synchronized articulation, failing to conform to natural human ergonomics during adjustment.

Accordingly, there remains a need in the art for a foldable and adjustable bed that simultaneously achieves ultra-compact storage, structural robustness in an expanded state, internal mechanism clearance without external legs, and smooth, quiet operation across multiple adjustable positions.

### SUMMARY OF THE INVENTION

The invention provides a compact, foldable and adjustable bed that addresses structural limitations of conventional adjustable beds, particularly with respect to folding thickness, actuator clearance, and floor placement capability.

In one aspect of the invention, the compact, foldable and adjustable bed comprises a base frame, a support platform, a front drive assembly, and a rear drive assembly.

The base frame comprises a front support frame and a rear support frame hinged to each other with a hinge connection mechanism. The front frame is a rectangular frame structure formed by a front support beam, a front connection beam, and a pair of front crank-type side rails. Each of the pair of front crank-type side rails comprises a horizontal portion having a first end and a second end, and an inclined portion having a first end joining with the second end of the horizontal portion and a second end, such that the inclined portion has an angle relative to the horizontal portion. The front support beam is mounted on the first end of each of the two horizontal portions. The front connection beam is connected to the second end of each of the two inclined rod portions.

The support platform comprises an upper limb board and a front seat board disposed on the front support frame, and a rear seat board and a lower limb board disposed on the rear support frame. The front seat board is fixed to a rear portion of the front support frame and hingedly connected to one end of the upper limb board. The rear seat board is fixed to a front portion of the rear support frame and hingedly connected to one end of the lower limb board.

The front drive assembly comprises a front drive actuator and a front drive bracket coupled to the front support frame and the upper limb board, configured to rotate the upper limb board relative to the front seat board.

The rear drive assembly comprises a rear drive actuator and a rear drive bracket coupled to the rear support frame and the lower limb board, configured to rotate the lower limb board relative to the rear seat board.

The front support frame and the rear support frame are configured to be foldable toward each other along the hinge connection mechanism therebetween to transition the bed from an expanded state to a storage state, and wherein in the storage state, the front drive actuator, the rear drive actuator, the front drive bracket, and the rear drive bracket are arranged in a staggered configuration.

The front support beam is configured to provide structural support in the expanded state, the front connection beam is configured to provide a structural clearance space required for folding into the folded storage state, and the front crank-type side rails are configured to increase an overall internal thickness of the support frame to internally accommodate pivotal travel of the front and rear drive assemblies.

In one embodiment, the front support beam defines a recessed clearance slot configured to accommodate a portion of the rear drive assembly when the support frame is in the storage state.

In one embodiment, the front support frame further comprises a plurality of front leveling slats disposed on the horizontal portion of the front crank-type side rails such that top surfaces of the front leveling slats, the front support beam, and the front connection beam are substantially coplanar to support the upper limb board and the front seat board in a flush, horizontal orientation when the bed is in the expanded state.

In one embodiment, the hinge connection mechanism comprises at least one hinge member pivotally connected to the front support frame and the support rear frame, wherein the hinge member comprises two symmetrically arranged hinge ears and a pivot pin extending through aligned pin apertures in the hinge ears, each hinge ear having a mounting portion and a connecting portion vertically extended from the mounting portion.

In one embodiment, the connecting portion of each hinge ear comprises a chamfered edge configured to prevent mechanical interference between the hinge ears during folding.

In one embodiment, the front drive assembly and the rear drive assembly are configured such that movement envelopes of the drive assemblies overlap in a vertical direction without mechanical interference when the bed is folded in the storage state.

In one embodiment, the front drive bracket is positioned toward one of a front side and a rear side of the front support frame, and the rear drive bracket is positioned at a corresponding opposite side of the rear support frame to facilitate the staggered configuration in the storage state.

In one embodiment, the front drive actuator is positioned on one of a left side and a right side of the front support frame, and the rear drive actuator is positioned on an opposite side of the rear support frame.

In one embodiment, the front drive bracket comprises a front rotation rod rotatably mounted to the pair of front crank-type side rails of the front support frame; and a pair of front lifting rods fixed respectively to two end portions of the front rotation rod, wherein rotation of the front rotation rod by the front drive actuator causes the front lifting rods to drive the rotation of the upper limb board.

In one embodiment, each of the front lifting rods includes at least one roller configured to abut and slide against the upper limb board during rotation.

In one embodiment, the front drive actuator has a first end connected to a front rail of the front support frame via a first front connection bracket and a second end connected to the front rotation rod of the front drive bracket via a second front connection bracket, such that an operation of the front drive actuator causes the rotation of the front rotation rod.

In one embodiment, the front support frame further comprising a front support bar having a first end fixed to the front support beam and a second end fixed to the front seat board.

In one embodiment, the front support bar is connected to the front drive bracket via a clamp structure.

In one embodiment, the clamp structure comprises a clamping member sleeved upon the front rotation rod; and a hoop sleeve disposed around the clamping member, the hoop sleeve having mounting ears with fixing holes configured to receive fasteners for attachment to the front support bar.

In one embodiment, the rear drive bracket is fixed to a bottom of the lower limb board and a hinge portion coupled to the rear drive actuator.

In one embodiment, the rear drive actuator has a first end connected to a rear rail of the rear support frame via a rear connection bracket and a second end connected to the hinge portion of the rear drive bracket, such that an operation of the rear drive actuator causes the rotation of the lower limb board.

In one embodiment, the lower limb board comprises a thigh board pivotally connected to the rear end of the rear seat board, and a calf board pivotally connected to a rear end of the thigh board; the rear frame further comprises a linkage rod having a first end pivotally connected to the rear support frame and a second end pivotally connected to the calf board; and to guide movement of the lower limb board; and the rear drive assembly is operably coupled to the thigh board, wherein rotation of the thigh board driven by the rear flipping assembly automatically coordinates a dependent rotation of the calf board via the linkage rod.

In one embodiment, at least one of the upper limb board and the lower limb board defines at least one avoidance opening configured to to prevent interference with the front drive actuator and/or the rear drive actuator during operation.

In one embodiment, in the storage state, the front support frame is nested within an interior of the rear support frame.

In one embodiment, the bed is configured to rest directly on a floor surface without support legs.

Accordingly, the invention provides a compact, low-profile, foldable adjustable bed structure that maintains reliable adjustment functionality while improving spatial efficiency and structural integration compared with conventional adjustable bed designs.

‎These and other aspects of the invention will become apparent from the following ‎description of ‎the preferred embodiment taken in conjunction with the following ‎drawings, although variations ‎and modifications therein may be affected without ‎departing from the spirit and scope of the ‎novel concepts of the invention.‎

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment.

FIG. 1 is an exploded perspective view of a compact, foldable and adjustable bed according to an embodiment of the invention.

FIG. 2A shows a partial exploded view of the foldable and adjustable bed‎ according to one embodiment of the invention.

FIG. 2B shows a partial exploded view of the foldable and adjustable bed‎ according to another embodiment of the invention.

FIG. 2C shows a partial enlarged view of the foldable and adjustable bed‎ of FIG. 1.

FIG. 3 is a top perspective view of the foldable and adjustable bed of FIG. 1 in an unfolded operational configuration.

FIG. 4 is a bottom perspective view of the foldable and adjustable bed of FIG. 1 in an unfolded operational configuration.

FIG. 5 is a perspective view of the foldable and adjustable bed of FIG. 1 in a folded storage configuration.

FIG. 6 is a partial perspective view of the foldable and adjustable bed of FIG. 1 in a folded storage configuration.

FIG. 7 is another partial perspective view of the foldable and adjustable bed of FIG. 1 in a folded storage configuration.

### DETAILED DESCRIPTION OF THE INVENTION

The invention will now be described more fully hereinafter with reference to the accompanying drawings, in which exemplary embodiments of the invention are shown. The invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting and/or capital letters has no influence on the scope and meaning of a term; the scope and meaning of a term are the same, in the same context, whether or not it is highlighted and/or in capital letters. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the invention or of any exemplified term. Likewise, the invention is not limited to various embodiments given in this specification.

The terminology used herein is for the purpose of describing particular embodiments only and is not intended to be limiting of the invention. As used herein, the singular forms “a,” “an,” and “the” are intended to include the plural forms as well, unless the context clearly indicates otherwise.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” to another feature may have portions that overlap or underlie the adjacent feature.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the invention.

Furthermore, relative terms, such as “lower” or “bottom” and “upper” or “top”, “front” and “rear”, and “left” and “right” may be used herein to describe one element's relationship to another element as illustrated in the figures. It will be understood that relative terms are intended to encompass different orientations of the device in addition to the orientation shown in the figures. For example, if the device in one of the figures is turned over, elements described as being on the “lower” side of other elements would then be oriented on the “upper” sides of the other elements. The exemplary term “lower” can, therefore, encompass both an orientation of lower and upper, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprise(s)” and/or “comprising,” or “include(s)” and/or “including” or “has (have)” and/or “having” or “contain(s)” and/or “containing” when used in this specification specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

As used herein, “around,” “about,” “substantially” or “approximately” shall generally mean within 20 percent, preferably within 10 percent, and more preferably within 5 percent of a given value or range. Numerical quantities given herein are approximate, meaning that the terms “around,” “about,” “substantially” or “approximately” can be inferred if not expressly stated.

As used in this specification, the phrase “at least one of A, B, and C” should be construed to mean a logical (A or B or C), using a non-exclusive logical OR. As used herein, the term “and/or” includes any and all combinations of one or more of the associated listed items.

As used in herein, the term “base frame” may also be referred to as a frame assembly, support frame, base structure, chassis, or structural frame. Similarly, the front support frame and rear support frame may alternatively be described as frame sections, frame portions, frame segments, or support subframes.

As used in herein, the terms “support platform” and associated “support boards” may also be referred to as support panels, support boards, body-support members, or articulated support elements. Individual support boards such as the upper limb board, seat board, or leg board may be referred to as body-support panels or adjustable support members configured to support corresponding portions of a user’s body.

The term “staggered” as used herein refers to a configuration in which two or more components are positioned in laterally or spatially offset locations such that the components do not vertically overlap when viewed along a given axis. In the context of the invention, the staggered arrangement of the front drive device and rear drive device refers to a configuration in which the drive assemblies are positioned on different lateral sides or otherwise offset positions of the frame so that the devices do not stack directly above one another when the bed frame is folded.

The term “avoidance opening” refers to a hole, recess, cutout, or other structural clearance feature formed in a support board or structural member to accommodate movement of a mechanical component. Such an opening allows a portion of a drive bracket or associated structure to enter the region of the structural member during movement in order to prevent mechanical interference.

The term “drive device,” “drive actuator,” or “actuator” refers to any assembly capable of generating controlled movement of a support board relative to the frame. Such assemblies may include electric linear actuators, motor-driven linkages, rotary actuators, or other powered or mechanically assisted motion systems.

The term “movement envelope”, used herein, refers to the total three-dimensional space that mechanical components of a device can reach or occupy during its normal range of motion. It is essentially a "safety bubble" defining the maximum vertical, horizontal, and/or angular limits of the movement of the device.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

The invention introduces a compact, foldable, and adjustable bed featuring a hinge-connected front and rear support frame combined with dual drive brackets that are arranged in an interleaved configuration when folded, thereby significantly reducing the folded thickness of the bed while enabling a legless flat-placement structure. The system further integrates compact rotational drive linkages, interference-avoidance openings, and a multi-segment articulated support board, allowing powered adjustment of upper and lower body sections while maintaining efficient spatial utilization in both folded and deployed states.

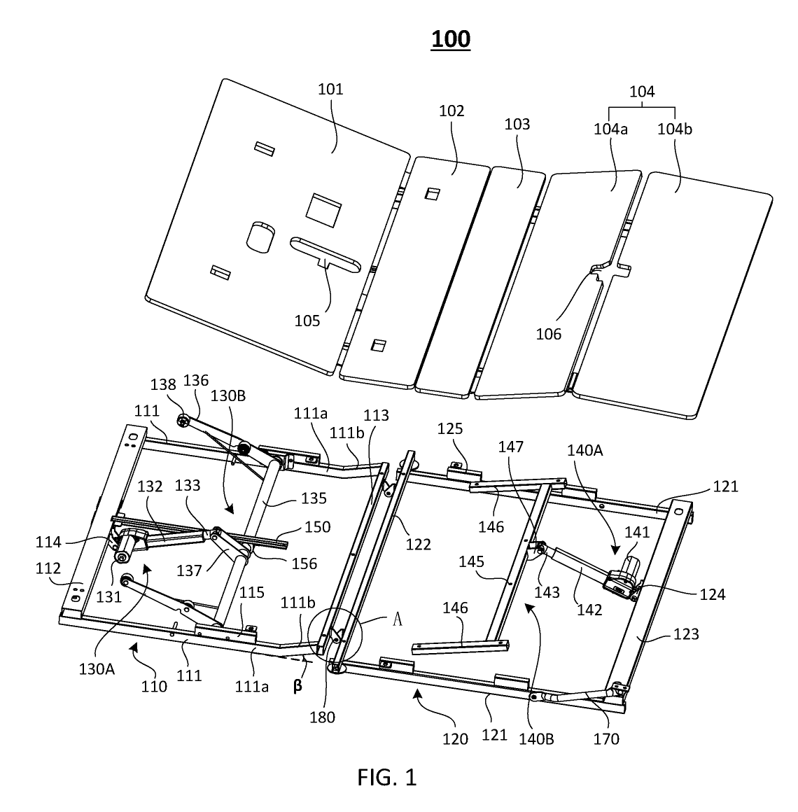

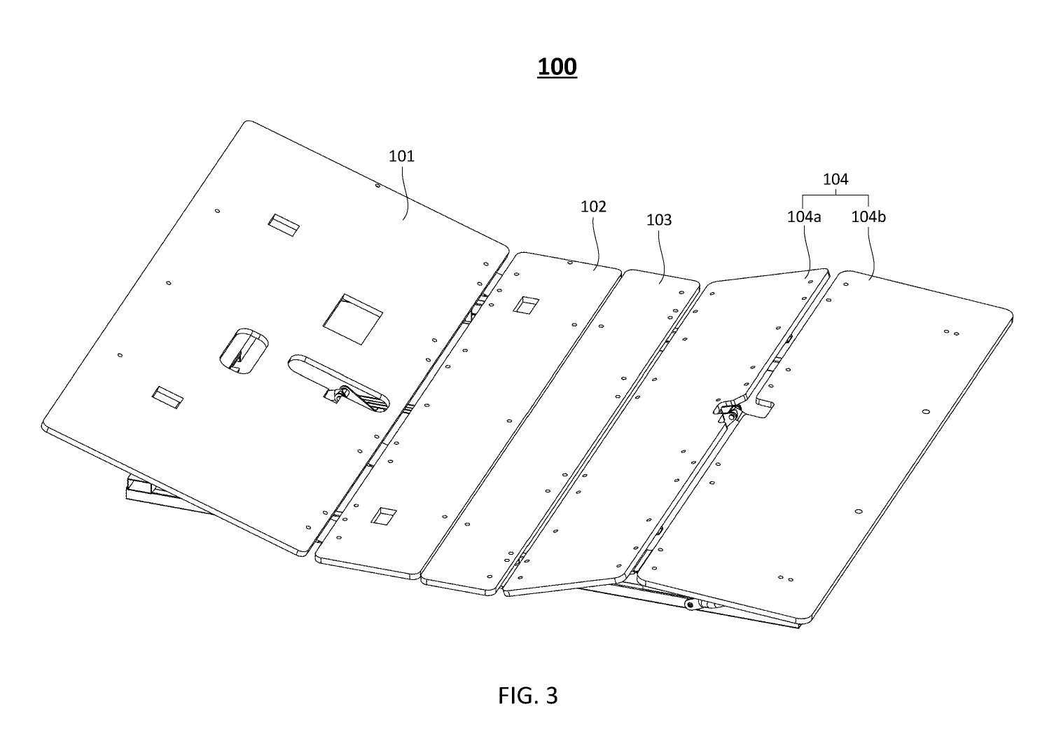

Referring to FIGS. 1-7, a compact, foldable and adjustable bed 100 according to an embodiment of the invention is a legless flat-folding bed. The bed 100 includes a base frame, a support platform, a front drive assembly, and a rear drive assembly.

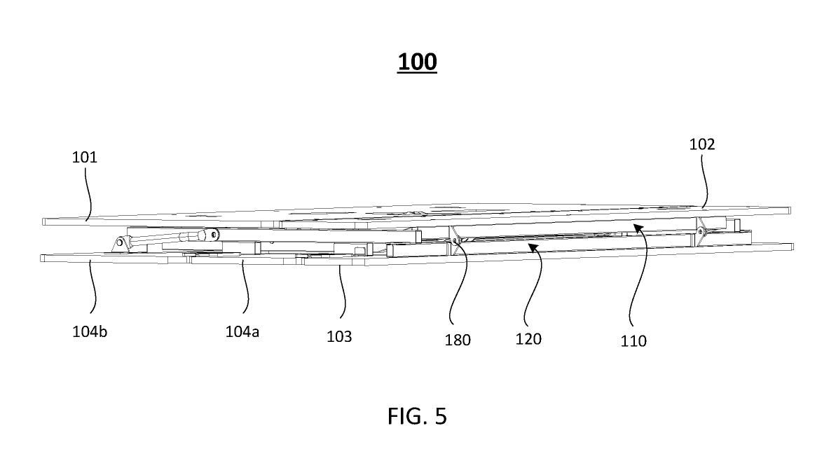

The base frame comprises a front support frame 110 and a rear support frame 120. The front support frame 110 and rear support frame 120 are hingedly connected to each other at adjacent ends by hinge members 180. In some embodiments, two rotation hinge members 180 are used, with ends thereof hinged to the corresponding front crank-type side rails 111 and rear side rails 121, respectively, allowing the front support frame 110 and rear support frame 120 to fold relative to each other. This hinged connection permits folding movement between an unfolded (expanded) state (FIGS. 1 and 3-4) suitable for use and a folded state (FIGS. 5-7) suitable for storage or shipping.

As best seen in FIGS. 1, 4 and 6-7, the front support frame 110 includes a pair of front crank-type side rails 111, a front support beam 112 and a front connection beam 113 connected to the pair of front crank-type side rails 111. The front support beam 112 is configured to provide structural support in the expanded state, the front connection beam 113 is configured to provide a structural clearance space required for folding into the folded storage state, and the front crank-type side rails 111 are configured to increase an overall internal thickness of the support frame to internally accommodate pivotal travel of the front and rear drive assemblies. Each front crank-type side rail 111 comprises a horizontal portion 111a having a first end and a second end, and an inclined portion 111b having a first end joining with the second end of the horizontal portion 111a and a second end, such that the inclined portion 111b has an angle, β, relative to the horizontal portion 111a (FIG. 1). The front support beam 112 is mounted on the first end of each of the two horizontal portions 111a, while the front connection beam 113 is connected to the second end of each of the two inclined portions 111b. The angle β is greater than 0 degrees and less than about 45 degrees. In some embodiments, the angle β can be any one of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, and 45degrees. The angle β and length of the inclined portion 111b and the thickness of the front connection beam 113 together define the overall internal thickness of the support frame to internally accommodate pivotal travel of the front and rear drive assemblies.

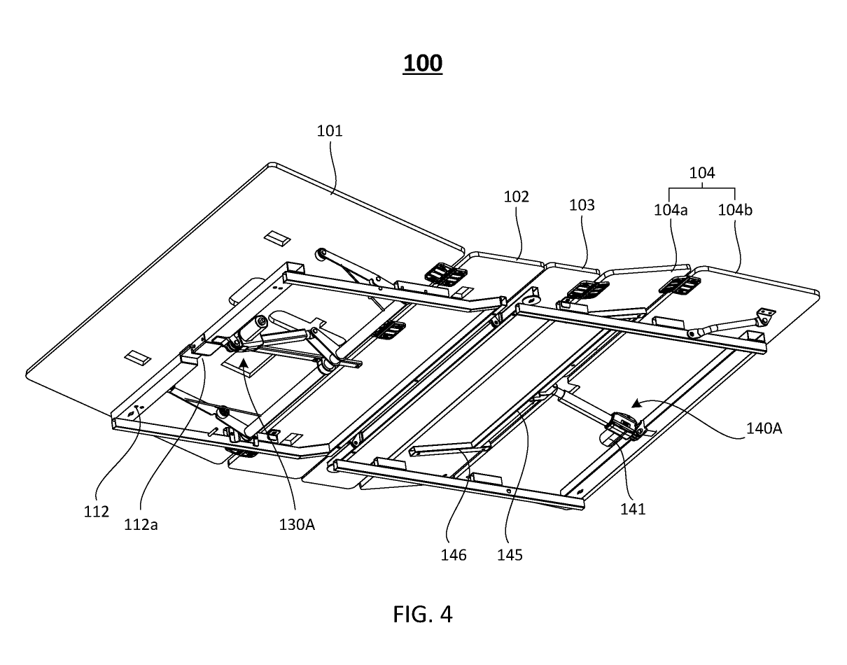

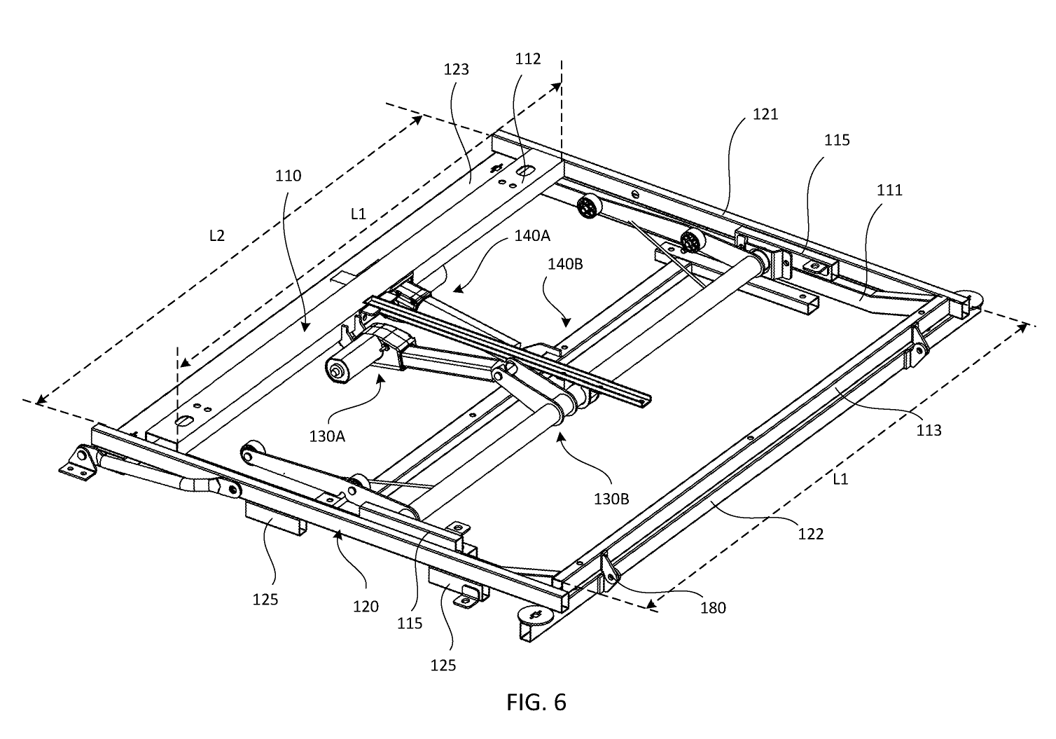

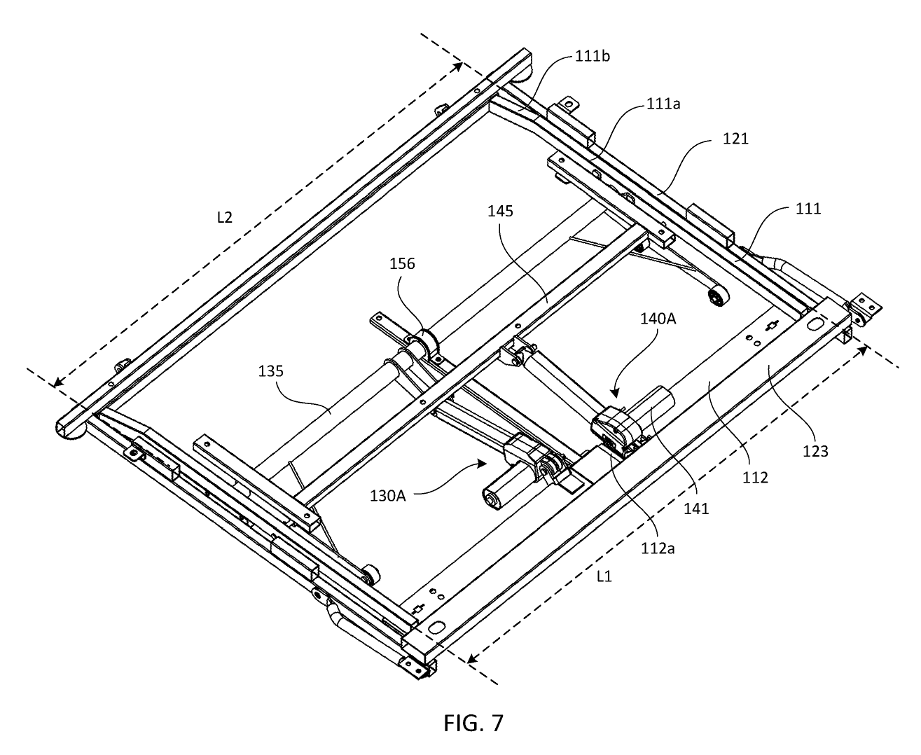

In some embodiments, the front support beam 112 defines a recessed clearance slot 112a (FIG. 4) configured to accommodate a portion of the rear drive assembly 140A when the support frame is in the storage state, as shown in FIGS. 6-7, thereby reducing overall folded thickness.

In some embodiments, the front support frame 110 further comprises a plurality of front leveling slats 115 disposed on the horizontal portion 111a of the front crank-type side rails 111 such that top surfaces of the front leveling slats 115, the front support beam 112, and the front connection beam 113 are substantially coplanar to support the upper limb board 101 and the front seat board 102 in a flush, horizontal orientation when the bed is in the expanded, flat state, as shown in FIGS. 1 and 5-6.

The rear support frame 120 is similarly a rectangular frame structure formed by a pair of side rails 121 and a rear support beam 123 and a rear connection beam 121 connected to the pair of side rails 121, as shown in FIGS. 1, 4 and 6-7. The rear support frame 120 may also include rear leveling slats 125 placed on the rear side rails 121, as shown in FIGS. 1 and 6. Similarly, top surfaces of the rear leveling slats 125, the rear support beam 123, and the rear connection beam 122 are substantially coplanar to support the lower limb board 104 and the rear seat board 103 in a flush, horizontal orientation when the bed is in the expanded, flat state, as shown in FIGS. 1 and 5-6.

Moreover, the top surfaces of the front leveling slats 115, the front support beam 112, and the front connection beam 113 of the front support frame 110, and the top surfaces of the rear leveling slats 125, the rear support beam 123, and the rear connection beam 122 of the rear support frame 120 are substantially coplanar to support the upper limb board 101 and the front seat board 102 in a flush, horizontal orientation when the bed is in the expanded, flat state.

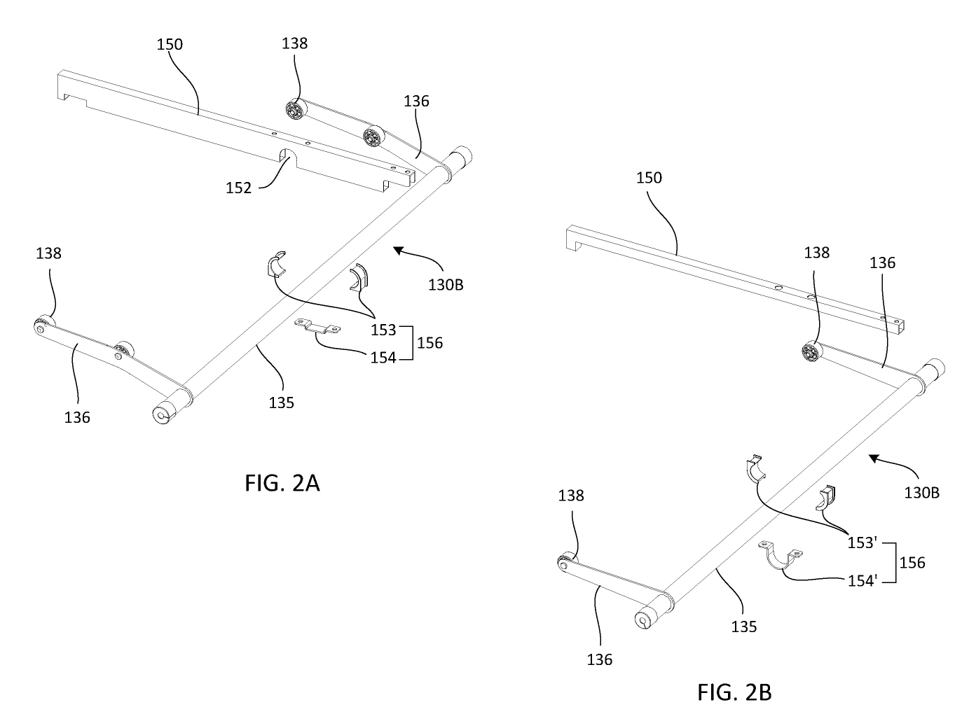

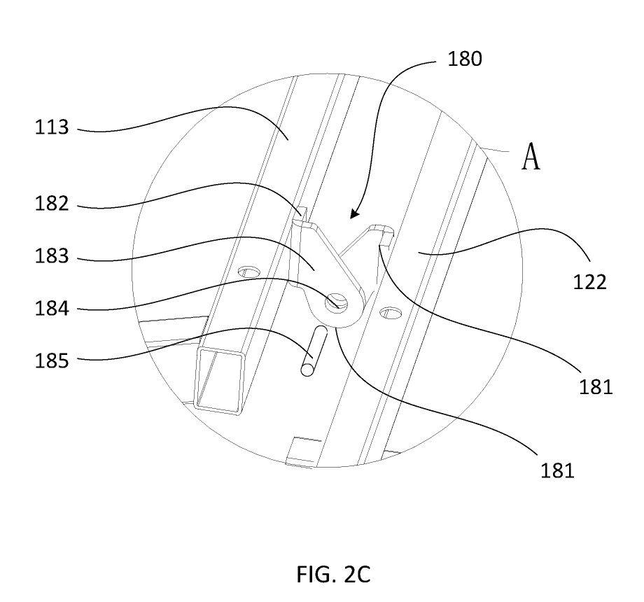

The front support frame 110 and rear support frame 120 are hingedly connected to each other at adjacent ends by one or more hinge members 180. As shown best in FIGS. 1 and 2C, each hinge member 180 comprises two symmetrically arranged hinge ears 181 and a pivot pin 185 extending through aligned pin apertures 184 formed in the hinge ears 181. Each hinge ear 181 has a mounting portion 182 operably mounted on to the front connection beam 113 of the front support frame 110 or the rear connection beam 121 of the rear support frame 120, and a connecting portion 183 vertically extended from the mounting portion 182. In one embodiment, as shown in FIG. 2C, the connecting portion 182 of each hinge ear 181 comprises a chamfered edge configured to prevent mechanical interference between the hinge ears 181 during folding.

In one embodiment, the front support frame 110 has an outer width, L1, and the rear support frame 120 has an inner width, L2, that is not less than L1, such that in the storage state, the front support frame 110 is nested at least partially within an interior of the rear support frame 120, as shown in FIGS. 6-7. This nesting design further saves storage space by reducing the overall footprint of the bed.

The support platform is supported by the frame and comprises a plurality of articulated board sections. In the illustrated embodiment, the support platform comprises an upper limb board 101 and a front seat board 102 placed on the front support frame 110, and a rear seat board 103 and a lower limb board 104 disposed on the rear support frame 120. The front seat board 102 is fixed to a rear portion of the front support frame 110 and hingedly connected to one end of the upper limb board 101. In one embodiment, the front seat board 102 is fixed to the top surfaces of the front leveling slats 115 and the front connection beam 113. The rear seat board 103 is fixed to a front portion of the rear support frame 120 and hingedly connected to one end of the lower limb board 104. In one embodiment, the rear seat board 103 is fixed to the top surfaces of the rear leveling slats 125 and the rear connection beam 122. This arrangement allows the upper limb board 101 and the lower limb board 104 to articulate relative to the front support frame 110 and the rear support frame 120 to adjust the bed's configuration for user comfort.

As shown in FIG. 1, the lower limb board 104 may further comprise a thigh board 104a and a lower leg board 104b hingedly connected to each other to provide additional adjustability, while the thigh board 104a is hingedly connected to the rear seat board 103. This segmented design allows for multiple angle adjustments of the lower limb, meeting different leg support needs of users. In addition, the rear support frame 120 also includes at least one linkage rod 170 pivotably connected between the rear support frame 120 and the lower leg board 104b to coordinate movement of the leg board. In some embodiments, two linkage rods 170 are provided. One end of the linkage rods 170 is hinged to the corresponding rear side rail 121 and the other end is hinged to the bottom sides of the lower leg board 104b. This design enhances the connection stability between the rear support frame 120 and the lower limb board 104 ensuring reliability during flipping and use.

Referring to FIGS. 1, 4, and 6-7, the front drive assembly is operatively associated with the front support frame 110 and the upper limb board 101. The front drive assembly comprises a front drive actuator 130A and a front drive bracket 130B, configured to rotate the upper limb board 101 relative to the front seat board 102.

The front drive actuator 130A is preferably an electric linear actuator, such as a motor-driven screw or piston, capable of extending and retracting to generate motive force. In one embodiment, the front drive actuator 130A comprises a motor member 131, an outer tube 132 extending from the motor member 131, and an activation rod 133 having a first end portion received in the outer tube 132 and an opposite, second end portion, wherein the activation rod 133 is engaged with the motor member 131 and configured to be telescopically movable relative to the outer tube 132 according to a direction of motor rotation. However, other actuator types may be employed without departing from the scope of the invention.

The front drive bracket 130B is pivotally mounted to the front support frame 110 and connects the front drive actuator 130A to the upper limb board 101. In the illustrated embodiment, the front drive bracket 103B comprises a front rotation rod 135 rotatably mounted to a pair of front crank-type side rails 111 of the front support frame 110, and a pair of front lifting rods 136 fixed respectively to two end portions of the front rotation rod 135, wherein rotation of the front rotation rod 135 by the front drive actuator 130A causes the front lifting rods 136 to drive the rotation of the upper limb board 101.

As best seen in FIG. 1, the front rotation rod 135 extends transversely across the front support frame 110 and is supported for rotation by the front crank-type side rails 112. The front lifting rods 136 are fixed to the front rotation rod 135 and extend radially therefrom. The front drive actuator 130A is coupled to the front rotation rod 135 such that extension or retraction of the front drive actuator 130A rotates the front rotation rod 135. Rotation of the front rotation rod 135 causes the front lifting rods 136 to swing in an arc, engaging the upper limb board 101 and lifting it relative to the front seat board 102.

In one embodiment as shown in FIGS. 1 and 4, the front drive actuator 130A has the motor member 133 pivotally connected to the front support beam 112 of the front support frame 110 via a first front connection bracket 114 and the second end portion of the activation rod 133 pivotally connected to the front rotation rod 135 of the front drive bracket 130B via a second front connection bracket 137, such that an operation of the front drive actuator 130A causes the rotation of the front rotation rod 135.

As shown in FIG. 1, at least one roller 138 is disposed at a distal end of each of the front lifting rods 136. The roller 138 bears against an underside of the upper limb board 101 and rolls along the board surface as the front lifting rods 136 swings, providing smooth and quiet operation. In the expanded state, the roller 138 abuts against the upper limb board 101. When the front lifting rods 136 drives the upper limb board 101 to flip, the front lifting rods 136 slide on the upper limb board 101 through the rollers 138. This reduces friction during the flipping process, makes the flipping of the upper limb board 101 smoother, and improves comfort and operation fluidity.

The front drive assembly 3 is supported and stabilized by a front support rod 150. As shown in FIG. 1, the front support bar 150 has a first end fixed to the front support beam 112 of the front support frame 110, and a second end fixed to the front seat board 102. The front support bar 150 enhances the structural rigidity of the connection between the frame and the support platform.

As best seen in FIG. 1, the front support bar 150 is connected to the front drive bracket 130B by a clamp structure 156. The clamp structure facilitates a stable connection between the front drive assembly and the bed frame. As shown in FIGS. 2A and 2B, the clamp structure 156 comprises a clamping member 153/153’ sleeved on the front rotation rod 135 of the front drive‎ bracket 130B, and a hoop sleeve (fixing bracket) 154/154’ fixing the clamping member 153/153’ to the front support bar 150, by, for example, screwing the fixing bracket 154/154’ to the the front support bar 150. The sleeve 154/154’ includes mounting ears with apertures for receiving fasteners that secure the clamp structure 156 to the front support bar 150. In one embodiment, the front support bar 150 has a notch 152 formed between the first and second ends for accommodating the clamping member 153 therein, as shown in FIG. 2A. ‎It should be noted that the clamping member 153/153’ can be any types of clamps as long as it can hold the front rotation rod 135 of the front drive‎ bracket 130B and allows the the front rotation rod 135 to rotate therein, and the fixing bracket 154/154’ can be any types of fixing brackets to fix the clamping member 153 to the connecting rod 150.

Accordingly, the use of the front support bar 150 to connect the first support frame 110, the first seat board 102 and the front drive assembly together makes the structural connection of the bed‎ 100 tighter, and the front drive actuator 130A drive the front drive bracket 130B to rotate more smoothly. By connecting the front rotation rod 135 to the front support bar 150, which is itself fixed to the front support frame 110 and the front seat board 102, the clamp structure 156 significantly enhances the connection strength and bearing capacity of the bed 100. This modular design allows for the front drive bracket 130B to be easily installed or removed for maintenance without requiring complex welding or permanent alterations to the frame. This arrangement provides a convenient and robust connection that simplifies assembly and maintenance.

Referring to FIGS. 1 and 4, the rear drive assembly is operatively associated with the rear support frame 120 and the lower limb board 104. The rear drive assembly comprises a rear drive actuator 140A and a rear drive bracket 140B coupled to the rear support frame 120 and the lower limb board 104 and configured to rotate the lower limb board 104 relative to the rear seat board 103.

The rear drive actuator 140A is preferably an electric linear actuator similar to the front drive actuator 130A. In one embodiment, the rear drive actuator 140A comprises a motor member 141, an outer tube 142 extending from the motor member 141, and an activation rod 143 having a first end portion received in the outer tube 142 and an opposite, second end portion, wherein the activation rod 143 is engaged with the motor member 141 and configured to be telescopically movable relative to the outer tube 142 according to a direction of motor rotation. However, other actuator types may be employed without departing from the scope of the invention.

The rear drive bracket 140B comprises a rear drive bracket 145 fixed to the bottom of the thigh board 104a and a hinge portion 147 coupled to the rear drive actuator 140A.

As shown in FIGS. 1 and 4, the rear drive bracket 145 is a rigid structure securely fastened to the bottom surface of the thigh board 104a. The rear drive bracket 145 can be a straight bar, a U-shape bar, a H-shape bar, a plate, or the like. In one embodiment shown in FIGS. 1 and 4, the rear drive bracket 145 includes a horizontal bar 145 and two arm bars 146 vertically extending from two ends of the horizontal bar 145. The hinge portion 147 provides a pivotal connection for the rear drive actuator 140A. The rear drive actuator 140A has a first end (e.g., the motor member 141) pivotally connected to the the rear cross rail 123 of the rear support frame 120 via a rear connection bracket 124 and a second end (e.g., the second end portion of the actuation rod 143) pivotally connected to the hinge portion 147. In one embodiment, the rear connection bracket 124 has a frame-like body attached to or integrated with the rear cross rail 123 of the rear support frame 120, and a tab downwards extending from the frame-like body and pivotally connected to the motor member 141. Extension of the rear drive actuator 140A pushes against the rear drive bracket 145, causing the thigh board 104a and the lower leg board 104b to pivot upward relative to the rear seat board 103. Retraction of the rear drive actuator 140A allows the the thigh board 104a and the lower leg board 104b to lower.

A key aspect of the invention is the staggered/interleaved configuration of the first and rear drive assemblies in the folded state, which dramatically reduces the overall thickness of the bed for storage and shipping. When the front support frame 110 and the rear support frame 120 are folded along their hinge junction (switching from expanded to storage state), the front drive actuator 130A and rear drive actuator 140A, as well as the front drive bracket 130B and the rear drive bracket 140B, are arranged in a staggered layout (interleaved arrangement).

Lateral Staggering: In some embodiments, as shown in FIGS. 1, 4 and 6-7, the front drive actuator 130A is mounted on one of a left side and a right side of the front support frame 110, while the rear drive actuator 140A is mounted on the opposite side (right or left) of the rear support frame 120. For example, the front drive actuator 130A is disposed on the right side of the front support frame 110, and the rear drive actuator 140A is disposed on the left side of the rear support frame 120. When the frames are folded, the right-side front drive actuator 130A and the left-side rear driver actuator 140B do not interfere, as shown in FIGS. 6-7. Simultaneously, the space required for front and rear driver movement overlaps in the thickness direction, reducing the overall thickness in the storage state.

Longitudinal Staggering: Similarly, the front drive bracket 130B may be mounted on the front or rear side of the front support frame 110, and the rear drive bracket 140B on the corresponding opposite side of the rear support frame 120. For example, the front drive bracket 130B is disposed on the front side of the front support frame 110, and the rear drive bracket 140B is disposed on the front side of the rear support frame 120. When folded, they do not interfere, and their required spaces overlap in the thickness direction, as shown in FIGS. 6-7.

This staggered layout significantly reduces the overall thickness of the bed in the storage state compared to conventional designs where components stack vertically.

Another key aspect of the invention is the clearance management system that enables the bed to operate flat on the floor without legs. The design of the front crank-type side rails 111 increases an overall internal thickness of the support frame to internally accommodate pivotal travel of the front and rear drive assemblies.

In addition, the use of the recessed clearance slot 112a defined in the front support beam 112 to accommodates a portion of the rear drive assembly 140A when the support frame is in the storage state further reduces overall folded thickness.

To further minimize the required clearance height beneath the boards, clearance apertures (avoidance openings) 105/106 are defined in at least one of the support boards, e.g., the upper limb board 101 and the thigh board 104a, and configured to to prevent interference with the front drive actuator and/or the rear drive actuator during operation. The avoidance aperture 105/106 is positioned to receive at least a portion of a drive system during articulation. By recessing the moving components into the board thickness, the required elevation provided by the pads is reduced. This allows the bed to sit close to the floor while still accommodating the full range of motion of the drive systems.

For example, the avoidance opening 105 is formed at a corresponding position of the upper limb board 101 to avoid interference when the front drive actuator 130A drives the front drive bracket 130B to rotate with the upper limb board 101, while the avoidance opening 106 is formed at a corresponding position of the lower limb board 104 (specifically the thigh board 104a) to avoid interference when the rear drive actuator 140A drives the rear drive bracket 140B to rotate with the lower limb board 104. The design of the avoidance openings 105/106 also overlaps a part of the space required for the activity of rear drive actuator 140A with the thickness of the thigh board 104a, further saving space.

In use, the foldable and adjustable bed is placed in the unfolded state on a floor or other support surface. When a user desires to adjust the bed configuration, the front drive actuator 130A and/or the rear drive actuator 140A are activated. Extension of the front drive actuator 130A rotates the front rotation rod 135, causing the front lifting rods 136 to swing upward. The rollers 138 bear against the upper limb board 101, lifting it to a desired angle. Extension of the rear drive actuator 140A pushes against the rear drive bracket 145, lifting the lower limb board 104. During articulation, the hinge portion 147 and a portion of the rear drive actuator 140A move into the avoidance aperture 106, as shown in FIG. 4, thereby preventing interference with the lower limb board 104. The front and rear drive actuators 10A and 140A may be independently actuated via a controller to adjust the upper limb board 101 and the lower limb board 104 to desired angles for reading, zero-gravity rest, or medical recovery. The low-friction rollers 130 and synchronized leg linkage 170 ensure smooth, quiet motion.

When the bed is to be stored or shipped, it is folded by pivoting the front support frame 110 about the hinge members 180 toward the rear support frame 120. As the frames approach each other, the front drive actuator 130A and rear drive actuator 140A assume their interleaved, laterally offset positions, minimizing the folded thickness. As shown in FIGS. 5-7, in the folded state, the front support frame 110 nests within the rear support frame 120 for further space optimization. The front drive bracket 130B and the rear drive bracket 140B may similarly interleave if longitudinally offset. The chamfered hinge ears 181 of the hinge members 180 prevents interference, while the recessed clearance slot 112a of the front support beam 112 receives part of the rear drive assembly 140B to reduce the thickness of the base frame when folded. The increased thickness provided by the front crank-type side rails 111 ensures all flipping components remain fully contained within the frame envelope, resulting in a highly compact, self-contained unit that requires no external legs and can be placed directly on floors or existing bed platforms.

Simultaneously, through the reasonable layout of the front drive actuator 130A, the rear driver actuator 140B, the front drive bracket 130B, and the rear drive bracket 140B, the space required at the bottom of the support platform for the front and rear drive assemblies to drive the support platform to flip in the expanded state is further saved, thereby meeting the scene requirement of the base frame being placed flat on the ground.

Although specific embodiments of the foldable and adjustable bed have been described above, the invention is not limited to the particular structures illustrated. Various alternative embodiments may be implemented while remaining within the scope of the invention.

In some embodiments, the front drive device and rear drive device may be arranged on opposite lateral sides of the frame but positioned at different longitudinal locations along the frame. Such arrangements may further reduce interference between the drive assemblies when the bed is folded.

In some embodiments, the avoidance openings may be formed in different support boards, including the leg board, thigh board, seat board, or other structural elements positioned above the drive brackets. The shape and size of the avoidance openings may vary depending on the geometry of the drive brackets.

Similarly, the avoidance openings formed in the support boards may vary in size, shape, or location depending on the geometry of the drive brackets and the movement paths of the actuating components. In some embodiments, the avoidance openings may be circular, rectangular, elongated, or irregular in shape. In other embodiments, the openings may be replaced by recessed regions, stepped structural portions, or other clearance structures that permit actuator components to occupy portions of the support board region during operation.

In some embodiments, the support platform may include additional articulated segments, such as separate thigh and leg boards, or may include additional hinges enabling more refined adjustment of body support angles.

The drive assemblies may include various types of actuators, such as electric linear actuators, motor-driven linkage brackets, or other powered adjustment brackets capable of rotating the support boards relative to the base frame.

In further embodiments, the staggered arrangement of the drive assemblies may be combined with additional structural features for reducing folded thickness, including recessed actuator mounting regions, stepped frame structures, or partially overlapping frame components.

Additionally, the front support frame and rear support frame may be configured so that one frame partially nests within the other frame when the bed is folded, thereby further reducing the folded volume.

The clamp structure may be replaced by other connection means, such as direct welding, bolting, or integral formation. The rollers may be replaced by low-friction pads or other bearing surfaces.

The structural components described herein may be modified in form, arrangement, or relative positioning while maintaining the functional principles of the invention. For example, the front drive device and rear drive device may be positioned at different longitudinal locations along the frame, mounted on different structural members, or integrated into alternative frame structures, provided that the drive assemblies remain arranged in a staggered or laterally offset configuration that reduces vertical overlap during folding.

The support platform may also include different numbers or arrangements of articulated support boards. For example, the leg-support region may include separate thigh and leg boards, additional hinge joints, or other adjustable segments that permit further adjustment of user body positioning. Likewise, the upper body support region may include additional adjustable sections or intermediate support panels.

The drive assemblies may include a variety of actuator types. In some embodiments, electric linear actuators may be used, while in other embodiments the adjustment may be achieved using rotary motors, linkage-driven brackets, cable-driven brackets, or other powered or mechanically assisted motion systems. The drive brackets may also include various linkages, shafts, rollers, or transmission components adapted to transmit motion from the actuators to the support boards.

Additionally, certain structural features described herein may be combined, separated, or rearranged in different ways. Components illustrated as separate structures in one embodiment may be integrated into a single component in another embodiment, and components illustrated as a single structure may be implemented as multiple components in alternative embodiments.

The foldable and adjustable bed disclosed herein provides several structural and functional improvements over conventional adjustable bed designs. Important technical features and advantages include the following.

Staggered actuator arrangement: The front drive device and rear drive device are arranged on opposite lateral sides of the bed frame in a staggered configuration. When the front and rear support frames are folded toward each other, the drive assemblies occupy laterally offset regions rather than vertically overlapping regions. This configuration prevents vertical stacking of the actuators and significantly reduces the folded thickness of the bed.

Compact folding structure: Because the actuators are laterally offset, the front support frame and rear support frame can be folded into a more compact configuration. The resulting folded structure occupies less vertical space than conventional foldable adjustable beds in which actuators are aligned along the same lateral side or central axis.

Avoidance openings for actuator movement: One or more support boards may include avoidance openings positioned to receive portions of the drive brackets during operation. These openings allow actuator components or associated drive frames to partially enter the thickness region of the support boards during adjustment, thereby reducing the required movement space beneath the bed frame.

Distributed actuator movement envelope: The combination of staggered actuators, avoidance openings, and bottom pads redistributes the actuator movement envelope in multiple directions. Portions of the actuator space are accommodated laterally, upward into the support board structure, and downward within the clearance defined by the pads.

Improved spatial efficiency: Through the above structural arrangement, the adjustable bed achieves reduced folded thickness, improved packaging efficiency, and a lower overall profile compared with conventional adjustable bed designs.

Enhanced compatibility with floor placement: Because the actuator movement space is managed within the frame structure and the limited clearance defined by the pads, the bed can be placed directly on a floor surface, platform, or other supporting surface while maintaining full adjustment functionality.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

What is claimed is:

1. A foldable and adjustable bed, comprising:
a base frame comprising a front support frame and a rear support frame hinged to each other with a hinge connection mechanism, wherein the front support frame is a rectangular frame structure formed by a front support beam, a front connection beam, and a pair of front crank-type side rails, wherein each of the pair of front crank-type side rails comprises a horizontal portion having a first end and a second end, and an inclined portion having a first end joining with the second end of the horizontal portion and a second end, such that the inclined portion has an angle relative to the horizontal portion, wherein the front support beam is mounted on the first end of each of the two horizontal portions, and wherein the front connection beam is connected to the second end of each of the two inclined rod portions;
a support platform comprising an upper limb board and a front seat board disposed on the front support frame, and a rear seat board and a lower limb board disposed on the rear support frame; wherein the front seat board is fixed to a rear portion of the front support frame and hingedly connected to one end of the upper limb board; wherein the rear seat board is fixed to a front portion of the rear support frame and hingedly connected to one end of the lower limb board;
a front drive assembly comprising a front drive actuator and a front drive bracket coupled to the front support frame and the upper limb board, configured to rotate the upper limb board relative to the front seat board; and
a rear drive assembly comprising a rear drive actuator and a rear drive bracket coupled to the rear support frame and the lower limb board, configured to rotate the lower limb board relative to the rear seat board;
wherein the front support frame and the rear support frame are configured to be foldable toward each other along the hinge connection mechanism therebetween to transition the bed from an expanded state to a storage state, and wherein in the storage state, the front drive actuator, the rear drive actuator, the front drive bracket, and the rear drive bracket are arranged in a staggered configuration; and
wherein the front support beam is configured to provide structural support in the expanded state, the front connection beam is configured to provide a structural clearance space required for folding into the folded storage state, and the front crank-type side rails are configured to increase an overall internal thickness of the support frame to internally accommodate pivotal travel of the front and rear drive assemblies.

2. The bed of claim 1, wherein the front support beam defines a recessed clearance slot configured to accommodate a portion of the rear drive assembly when the support frame is in the storage state.

3. The bed of claim 1, wherein the front support frame further comprises a plurality of front leveling slats disposed on the horizontal portion of the front crank-type side rails such that top surfaces of the front leveling slats, the front support beam, and the front connection beam are substantially coplanar to support the upper limb board and the front seat board in a flush, horizontal orientation when the bed is in the expanded state.

4. The bed of claim 1, wherein the hinge connection mechanism comprises at least one hinge member pivotally connected to the front support frame and the support rear frame, wherein the hinge member comprises two symmetrically arranged hinge ears and a pivot pin extending through aligned pin apertures in the hinge ears, each hinge ear having a mounting portion and a connecting portion vertically extended from the mounting portion.

5. The bed of claim 4, wherein the connecting portion of each hinge ear comprises a chamfered edge configured to prevent mechanical interference between the hinge ears during folding.

6. The bed of claim 1, wherein the front drive assembly and the rear drive assembly are configured such that movement envelopes of the drive assemblies overlap in a vertical direction without mechanical interference when the bed is folded in the storage state.

7. The bed of claim 6, wherein the front drive bracket is positioned toward one of a front side and a rear side of the front support frame, and the rear drive bracket is positioned at a corresponding opposite side of the rear support frame to facilitate the staggered configuration in the storage state.

8. The bed of claim 6, wherein the front drive actuator is positioned on one of a left side and a right side of the front support frame, and the rear drive actuator is positioned on an opposite side of the rear support frame.

9. The bed of claim 1, wherein the front drive bracket comprises:
a front rotation rod rotatably mounted to the pair of front crank-type side rails of the front support frame; and
a pair of front lifting rods fixed respectively to two end portions of the front rotation rod, wherein rotation of the front rotation rod by the front drive actuator causes the front lifting rods to drive the rotation of the upper limb board.

10. The bed of claim 9, wherein each of the front lifting rods includes at least one roller configured to abut and slide against the upper limb board during rotation.

11. The bed of claim 9, wherein the front drive actuator has a first end connected to a front rail of the front support frame via a first front connection bracket and a second end connected to the front rotation rod of the front drive bracket via a second front connection bracket, such that an operation of the front drive actuator causes the rotation of the front rotation rod.

12. The bed of claim 9, wherein the front support frame further comprising a front support bar having a first end fixed to the front support beam and a second end fixed to the front seat board.

13. The bed of claim 12, wherein the front support bar is connected to the front drive bracket via a clamp structure.

14. The bed of claim 13, wherein the clamp structure comprises:
a clamping member sleeved upon the front rotation rod; and
a hoop sleeve disposed around the clamping member, the hoop sleeve having mounting ears with fixing holes configured to receive fasteners for attachment to the front support bar.

15. The bed of claim 1, wherein the rear drive bracket is fixed to a bottom of the lower limb board and a hinge portion coupled to the rear drive actuator.

16. The bed of claim 15, wherein the rear drive actuator has a first end connected to a rear rail of the rear support frame via a rear connection bracket and a second end connected to the hinge portion of the rear drive bracket, such that an operation of the rear drive actuator causes the rotation of the lower limb board.

17. The bed of claim 1, wherein the lower limb board comprises a thigh board pivotally connected to the rear end of the rear seat board, and a calf board pivotally connected to a rear end of the thigh board;
wherein the rear frame further comprises a linkage rod having a first end pivotally connected to the rear support frame and a second end pivotally connected to the calf board; and to guide movement of the lower limb board; and
wherein the rear drive assembly is operably coupled to the thigh board, wherein rotation of the thigh board driven by the rear flipping assembly automatically coordinates a dependent rotation of the calf board via the linkage rod.

18. The bed of claim 1, wherein at least one of the upper limb board and the lower limb board defines at least one avoidance opening configured to to prevent interference with the front drive actuator and/or the rear drive actuator during operation.

19. The bed of claim 1, wherein in the storage state, the front support frame is nested within an interior of the rear support frame.

20. The bed of claim 1, wherein the bed is configured to rest directly on a floor surface without support legs.
